(19) United States
(12) Patent Application Publication
(10) Pub. No.: US 2023/0392669 A1
(43) Pub. Date: Dec. 7, 2023

(54) TURNBUCKLE

(71) Applicant: CHING-SHUI HUANG, Taichung (TW)

(72) Inventor: CHING-SHUI HUANG, Taichung (TW)

(21) Appl. No.: 17/829,372

(22) Filed: Jun. 1, 2022

(51) Int. Cl. F16G 11/12

(52) U.S. Cl. CPC F16G 11/12

(57) ABSTRACT

A turnbuckle includes an interconnector and two terminal elements. The interconnector includes two nut-like portions extending from a closed hollow body. The closed hollow body includes a chamber. Each of the nut-like portions includes s a screw hole. Each of the terminal elements includes a threaded portion inserted in a corresponding one of the screw holes.

### BACKGROUND OF INVENTION

### 1. Field of Invention

The present invention relates to turnbuckles and, more particularly, to a robust turnbuckle.

### 2. Related Prior Art

Referring to FIG. 6, a conventional turnbuckle 80 includes an interconnector 81 and two hooks 86. The interconnector 81 includes two bars 84 formed between two nut-like portions 82. There are two gaps 85 between the bars 84. Like a nut, each of the nut-like portions 82 includes a screw hole 83. Each of the hooks 86 includes an arched portion 87 and a threaded portion 88. The threaded portion 88 of each of the hooks 86 is inserted in the screw hole 83 of one of the nut-like portions 82.

In operation, the arched portion 87 of each of the hooks 86 is used to hook a looped end of a rope or cable. An opposite end of each of the ropes is tied to an object. Then, a rod is extended through the gaps 85 between the bars 84 and operated to spin the interconnector 81 relative to the hooks 86. Thus, the screw holes 83 of the nut-like portions 82 of the interconnector 81 cooperate with the threaded portions 88 of the hooks 86 to move the hooks 86 toward each other. Thus, the looped ends of the ropes are moved toward each other, i.e., the ropes are tightened between the objects.

The interconnector 81 is made of zinc or/and aluminum by casting. However, the use of the turnbuckle 80 is not without any problems. Firstly, it is inexpensive. Secondly, it is week and does not last long. Thirdly, the rod is weak since its diameter is limited by the width of the gaps 85.

To solve the foregoing problem, U.S. Pat. No. 5,908,261 discloses molding an interconnector and addition of elongated fibers in two bars of the interconnector while molding. The resultant interconnector is not robust enough.

Taiwanese Patent No. 1305161 discloses a method for making an interconnector. At first, a tube 11 is made of metal. Then, two terminal sections 12 of the tube 11 are reduced in diameter. Then, two slits 13 are made in a middle section of the tube 11 by punching. Accordingly, two bent portions 14 are made one two opposite sides of each of the slits 13. Then, each of the terminal sections 12 of the tube 11 is made with screw hole by tapping. However, the interconnector is still not robust enough or lasts long enough even with the use of the bent portions 14.

The present invention is therefore intended to obviate or at least alleviate the problems encountered in the prior art.

### SUMMARY OF INVENTION

It is the primary objective of the present invention to provide a robust turnbuckle.

To achieve the foregoing objective, the turnbuckle includes an interconnector and two terminal elements. The interconnector includes two nut-like portions extending from a closed hollow body. The closed hollow body includes a chamber. Each of the nut-like portions includes s a screw hole. Each of the terminal elements includes a threaded portion inserted in a corresponding one of the screw holes.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is an exploded view of a turnbuckle according to the first embodiment of the present invention;

FIG. 2 is a side view of the turnbuckle shown in FIG. 1;

FIG. 3 is a cross-sectional view of the turnbuckle shown in FIG. 1;

FIG. 4 is a side view of the turnbuckle shown in FIG. 1;

FIG. 5 is a perspective view of a turnbuckle according to the second embodiment of the present invention; and

FIG. 6 is a perspective view of a conventional turnbuckle.

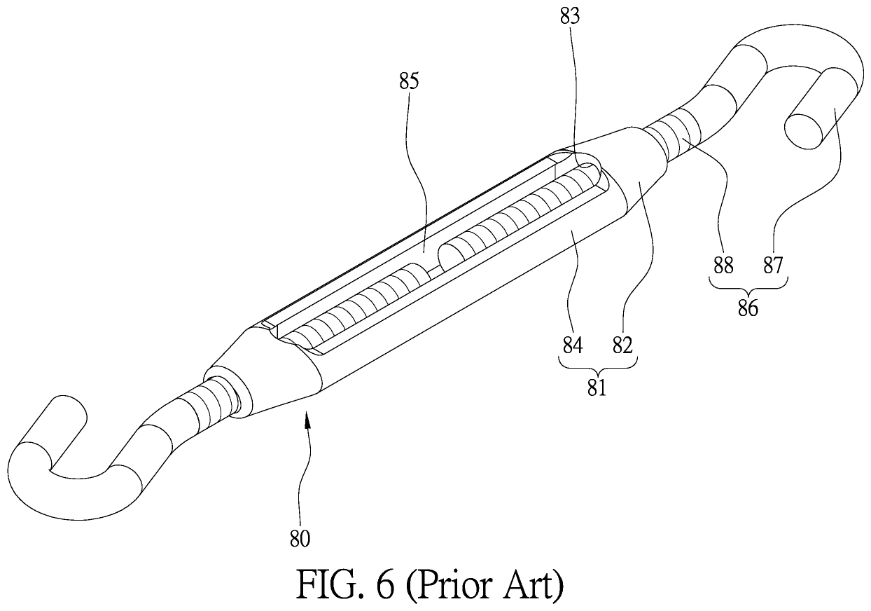

### DETAILED DESCRIPTION OF EMBODIMENTS

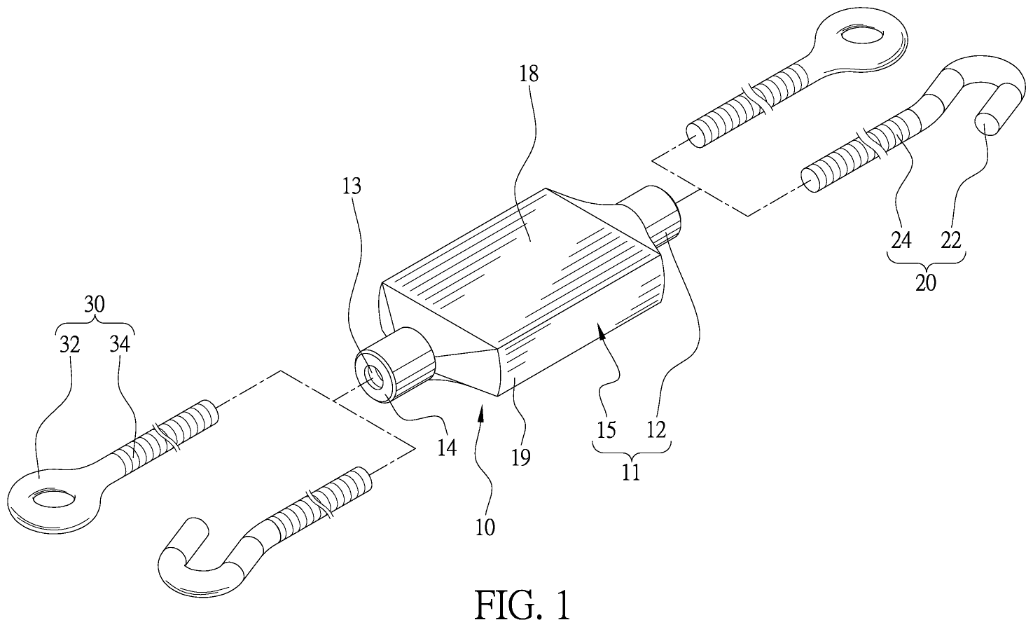

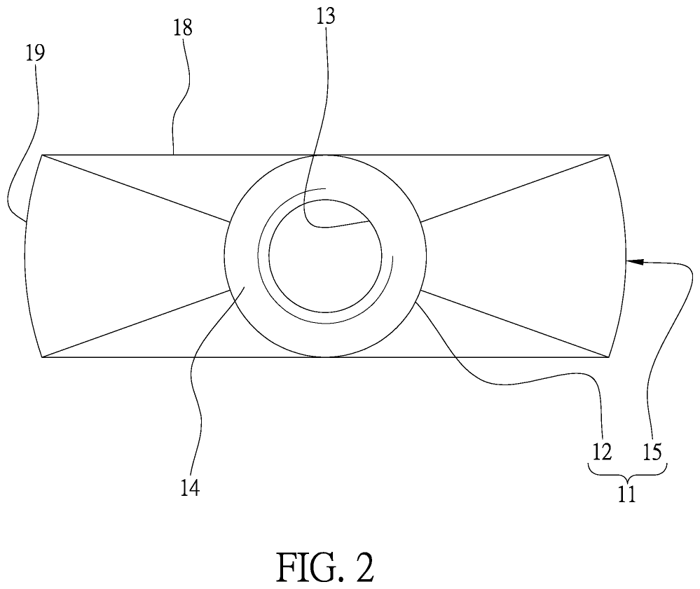

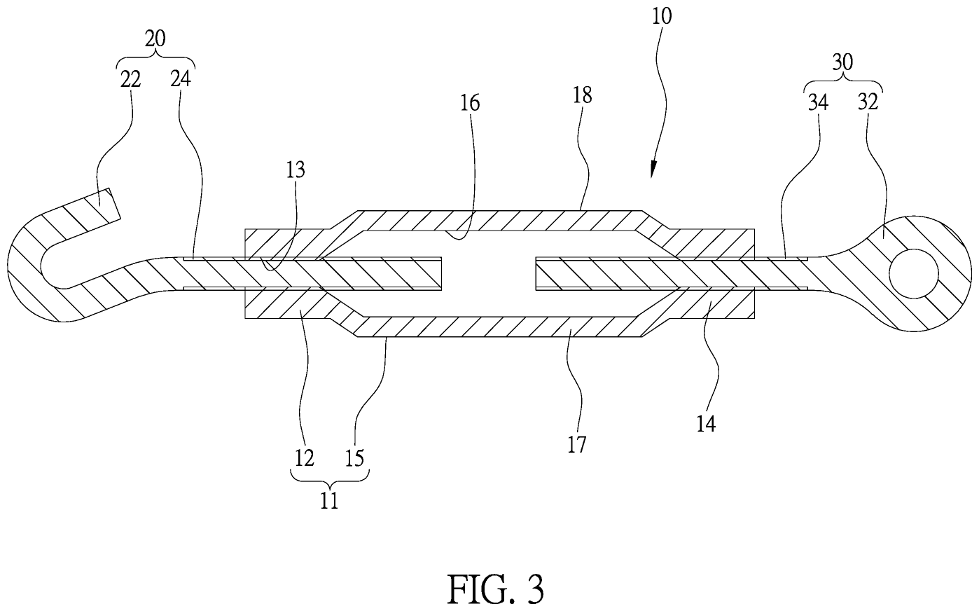

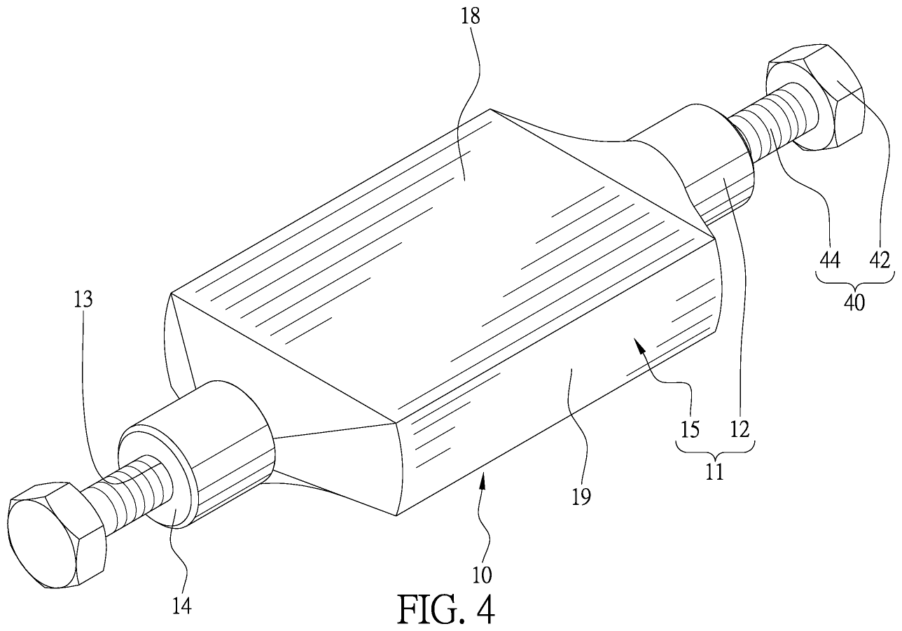

Referring to FIGS. 1 through 4, a turnbuckle includes a tubular interconnector 11 and two terminal elements according to a first embodiment of the present invention. Each of the terminal elements can be a hook 20 (FIGS. 1 and 3), a loop 30 (FIGS. 1 and 3) or a threaded bolt 40 (FIG. 4). In operation, the hooks 20, the loops 30 and the threaded bolts 40 are used in various combination as follows:

Both the hooks 20 are used with the tubular interconnector 11;

Both the loops 30 are used with the tubular interconnector 11;

One of the hooks 20 and one of the loops 30 are used with the tubular interconnector 11; or

Both the threaded bolts 40 are used with the tubular interconnector 11.

Referring to FIGS. 1 through 3, the interconnector 10 includes two nut-like portions 12 extending from two opposite ends of a closed hollow body. The closed hollow body is a box 15 in the first embodiment. That is, each of the nut-like portions 12 is a terminal section of the interconnector 10 and the box 15 is the middle section of the interconnector 10. The interconnector 10 gets tapered toward each of the nut-like portions 12 from the box 15.

Each of the nut-like portions 12 includes a screw hole 13 made in thick wall 14. The box 15 includes chamber 16 made in a thin wall 17. The thick walls 14 are thick in comparison with the thin wall 17. Preferably, each of screw holes 13 is in communication with the chamber 16. On the outside, the box 15 includes two planes 18 extending between two arched faces 19.

The hooks 20 and the loops 30 are made of metal. Each of the hooks 20 includes an arched portion 22 at an end and a threaded portion 24 at another end. Each of the loops 30 included a looped portion 32 at an end and a looped portion 32 at another end.

The threaded portion 24 of each of the hooks 20 or the threaded portion 34 of each of the loops 30 is inserted in the screw hole 13 of one of the nut-like portions 12.

In operation, the arched portion 22 of each of the hook 20 or the looped portion 32 of each of the loops 30 is connected to a compliant end of a rope or chain (not shown). Another end of each of the ropes or chains is tied to an object. A tool (not shown) is used to spin the box 15 relative to the hooks 20 or the loops 30. Such a tool can be a spanner, a wrench or a monkey wrench for example.

The screw holes 13 cooperate with the threaded portions 24 and/or 34 to bring the hooks 20, the loops 30, or the hook 20 and the loop 30 toward each other. Thus, the ropes or chains are tightened between the objects.

Referring to FIG. 4, each of the threaded bolts 40 includes a head 42 and a threaded portion 44. The head 42 is made with a hexagonal profile. The threaded portion 44 of each of the threaded bolts 40 is inserted in one of the screw holes 13. The heads 42 are located out of the interconnector 11.

In operation, the threaded portion 44 of each of the threaded bolts 40 is extended through an aperture made in an object before the threaded portion 44 of each of the threaded bolts 40 is inserted in one of the screw holes 13. The head 42 of each of the threaded bolts 40 is abutted against one of the objects. The interconnector 11 is spun relative to the threaded bolts 40 so that the turnbuckle is tightened between the objects, i.e., the objects are moved toward each other.

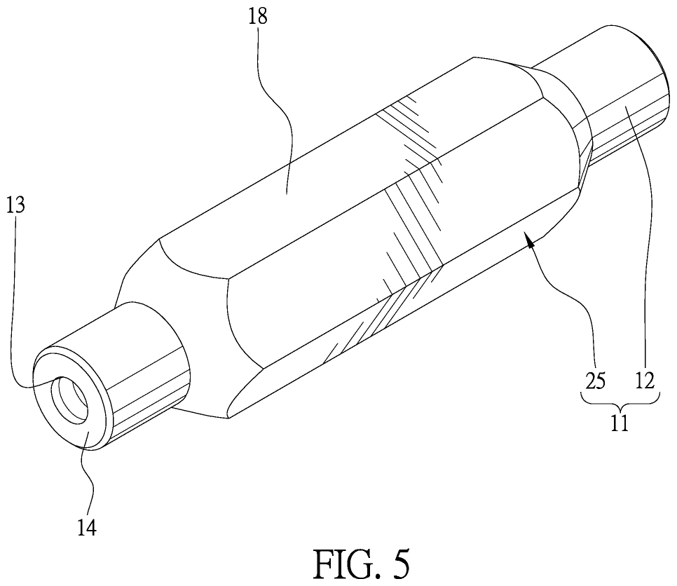

Referring to FIG. 5, there is an interconnector of a turnbuckle according to a second embodiment of the present invention. The second embodiment is like the first embodiment except for that the closed hollow body is a tube 25 instead of the box 15. The tube 25 includes six planes 18, i.e., without any arched face like the arched faces 19.

The turnbuckle exhibits several advantages over the prior art. Firstly, the interconnector 10 or 11 is closed in operation. Hence, the interior of the interconnector 10 or 11 is kept clean in operation. Secondly, the interconnector 10 or 11 is robust for not including any slit or slot. Thirdly, the turnbuckle can be used with a tool to exert a larger torque than a rod which is sometimes too thin to exert an adequate torque.

The present invention has been described via the illustration of the embodiments. Those skilled in the art can derive variations from the embodiments without departing from the scope of the present invention. Therefore, the embodiments shall not limit the scope of the present invention defined in the claims.

1. A turnbuckle comprising:
an interconnector comprising:
a closed hollow body comprising a chamber; and
two nut-like portions extending from the closed hollow body, wherein each of the nut-like portions comprises a screw hole; and
two terminal elements each of which comprises a threaded portion inserted in a corresponding one of the screw holes.

2. The turnbuckle according to claim 1, wherein the closed hollow body comprises a wall around the chamber, wherein each of the nut-like portions comprises a wall around the screw hole, and wherein the wall of the closed hollow body is thinner than the wall of each of the nut-like portions.

3. The turnbuckle according to claim 1, wherein the closed body is a box.

4. The turnbuckle according to claim 3, wherein the wall of the box comprises two planes and two arched faces extending between the planes.

5. The turnbuckle according to claim 1, wherein the closed body is a tube.

6. The turnbuckle according to claim 1, wherein the wall of the tube comprises six planes.

7. The turnbuckle according to claim 1, wherein one of the terminal elements is a hook comprising an arched portion opposite to the threaded portion.

8. The turnbuckle according to claim 1, wherein one of the terminal elements is a loop comprising a looped portion formed opposite to the threaded portion.

9. The turnbuckle according to claim 1, wherein one of the terminal elements is a threaded bolt comprising a head formed opposite to the threaded portion.

10. The turnbuckle according to claim 9, wherein the head comprises a hexagonal profile.

11. The turnbuckle according to claim 1, wherein the chamber is in communication with each of the screw holes.
